(19) United States
(12) Patent Application Publication
(10) Pub. No.: US 2025/0373946 A1
(43) Pub. Date: Dec. 4, 2025

(54) SENSOR DRIVING DEVICE

(71) Applicant: AAC Microtech (Changzhou) Co., Ltd., Changzhou City (CN)

(72) Inventors: Zhang Ren, Changzhou (CN); Yun Tang, Changzhou (CN); Wei Song, Changzhou (CN)

(21) Appl. No.: 19/011,438

(22) Filed: Jan. 6, 2025

Related U.S. Application Data
(63) Continuation of application No. PCT/CN2024/096758, filed on May 31, 2024.

(51) Int. Cl. H04N 23/68; G02B 27/64

(52) U.S. Cl. CPC H04N 23/685; G02B 27/646

(57) ABSTRACT

Provided is a sensor driving device, including: a housing, a sensor module, an elastic support assembly, driving coils, and driving magnets. There are a plurality of groups of driving coils spaced apart from each other. Each group of driving coils includes two coils perpendicular to each other, and driving directions of the two coils are perpendicular to the optical axis, and an orthographic projection of one coil toward the other coil is at least partially located within the other coil. There are a plurality of groups of driving magnets spaced apart from each other. The driving magnets are corresponding to and spaced apart from the driving coils. The driving magnets interact with the driving coils to drive the sensor module to move in a direction perpendicular to the optical axis. The sensor driving device has a large rotational torque, good driving effect, and good anti-shaking performance.

### CROSS-REFERENCE TO RELATED APPLICATIONS

This application is a continuation of International Application No. PCT/CN2024/096758, May 31, 2024, the entire contents of which is incorporated herein by reference.

### TECHNICAL FIELD

The present application relates to the technical field of driving apparatuses, in particular to a sensor driving device.

### BACKGROUND

With the development of camera technology, the sensor driving device is widely used in various camera devices. The combination of the sensor driving device with various portable electronic devices such as mobile phones, video cameras, computers, etc. is even more favored by consumers.

The driving mechanism of the sensor driving device described in the related art is usually formed by a driving coil and a magnet to form a driving structure, a support frame is supported on a base, and a sensor module is set in an accommodating space of the support frame. The sensor module is suspended in the accommodating space by an elastic support assembly, a magnet is fixed to the base, and a driving coil is fixed to the elastic support assembly. When a current is applied by the driving coil, an electromagnetic field is generated between the driving coil and the magnet, and the driving coil is subjected to the Lorentz force of the electromagnetic field, which drives the driving coil to move in the direction perpendicular to the optical axis of the sensor module, thereby driving the sensor module to realize anti-shaking performance.

However, in the sensor driving device of the related art, since the driving coil mainly provides a rotational driving force by relying on the upper and lower two corresponding driving coils, the rotational torque is small, the driving effect is poor, and the anti-shaking effect is poor.

Therefore, it is necessary to provide a new sensor driving device to solve the above problem.

### SUMMARY

The technical problem to be solved by the present application is to provide a sensor driving device with a large rotational torque, a good driving effect and a good anti-shaking performance.

To solve the above technical problem, the present application provides a sensor driving device including:
a housing provided with an accommodating space and a through-hole connecting the accommodating space to the outside world;
a sensor module accommodated within the accommodating space and directly opposite the through-hole;
an elastic support assembly fixed to an inner side of the housing and suspending the sensor module within the accommodating space;
driving coils fixed to the sensor module; and
driving magnets fixed to the housing and spaced opposite the driving coil; wherein the driving coils interact with the driving magnets and drive the elastic support assembly to move in a direction perpendicular to an optical axis of the sensor module, to drive the sensor module in synchronous movement;
wherein the driving coils include a plurality of groups, which are spaced apart from each other; each group of the driving coils includes two coils perpendicular to each other, driving directions of the two coils of each group are perpendicular to the optical axis toward the sensor module and perpendicular to the optical axis back away from the sensor module, respectively; and an orthographic projection of one coil of each group toward the other coil is at least partially located within the other coil;
the driving magnets include a plurality of groups, which are spaced apart from each other; each group of the driving magnets is spaced apart from each group of the driving coils correspondingly, and the plurality of groups of the driving magnets interact with the plurality of groups of the driving coils to drive the sensor module to move in a direction perpendicular to the optical axis.

In one embodiment, the orthographic projection of one coil of each group toward the other coil is located flush with the other coil.

In one embodiment, the plurality of groups of the driving coils include a first group of driving coils, a second group of driving coils, a third group of driving coils, and a fourth group of driving coils respectively fixed to a peripheral side of the sensor module; wherein the first group of driving coils and the second group of driving coils are spaced side by side and located on one side of the sensor module, the third group of driving coils and the fourth group of driving coils are spaced side by side and located on the other side of the sensor module; and the first group of driving coils and the fourth group of driving coils are provided diagonally;
the driving magnets include a first driving magnet, a second driving magnet, a third driving magnet, and a fourth driving magnet respectively fixed to the housing; wherein the first driving magnet, the second driving magnet, the third driving magnet, and the fourth driving magnet are spaced apart from each other and located at the peripheral side of the sensor module; the first driving magnet, the second driving magnet, the third driving magnet, and the fourth driving magnet interact with the first group of driving coils, the second group of driving coils, the third group of driving coils, and the fourth group of driving coils, respectively, and drive the sensor module to move.

In one embodiment, one coil of the first group of driving coils and one coil of the second group of driving coils are parallel to each other and driven in the same direction, and the other coil of the first group of driving coils and the other coil of the second group of driving coils are flush with each other and driven in the opposite direction;
one coil of the first group of driving coils and one coil of the third group of driving coils are flush with each other and driven in the opposite direction, and the other coil of the first group of driving coils and the other coil of the third group of driving coils are parallel to each other and driven in the same direction;
one coil of the first group of driving coils and one coil of the fourth group of driving coils are parallel to each other and driven in the opposite direction, and the other coil of the first group of driving coils and the other coil of the fourth group of driving coils are parallel to each other and driven in the opposite direction.

In one embodiment, the elastic support assembly includes an elastic arm provided in the housing, two connecting portions respectively extending from opposite sides of the elastic arm toward an inner side of the elastic arm, a movable portion fixed between the two connecting portions, a first fixing portion formed by recessing the other opposite sides of the elastic arm, and a mounting portion fixed to a side of the movable portion away from the sensor module; the sensor module is fixed to the mounting portion and the first fixing portion is fixed to the housing.

In one embodiment, the sensor driving device further includes a first anti-collision block and a second anti-collision block, wherein the first anti-collision block and the second anti-collision block are provided on the two connecting portions, respectively; and a side of the first anti-collision block away from the elastic arm and a side of the second anti-collision block away from the elastic arm are abutted against the movable portion.

In one embodiment, the sensor driving device further includes a first damping member and a second damping member, wherein opposite ends of the first damping member are fixed to the housing and the first anti-collision block, respectively; and opposite ends of the second damping member are fixed to the housing and the second anti-collision block, respectively.

In one embodiment, the housing includes a bottom cover and an upper cover fixed to the bottom cover and enclosing the accommodating space together with the upper cover; the elastic support assembly is fixed to a side of the bottom cover close to the upper cover;
the first driving magnet, the second driving magnet, the third driving magnet, and the fourth driving magnet are each provided with two magnets; the two magnets are fixed to the bottom cover and the top cover, respectively; and the two magnets are spaced apart on two sides of the first group of driving coils, the second group of driving coils, the third group of driving coils and the fourth group of driving coils.

In one embodiment, the top cover includes a top cover body fixed to the bottom cover and in a rectangular shape, a support portion formed by an end of the top cover body away from the bottom cover extending along one side of the sensor module, and a second fixing portion and a third fixing portion formed by a side of the support portion close to the bottom cover bending and extending oppositely; the through-hole is formed in the support portion, and the first damping member and the second damping member are provided on a side of the second fixing portion close to the bottom cover and a side of the third fixing portion close to the bottom cover, respectively.

In one embodiment, the sensor driving device further includes a conductive member, wherein one end of the conductive member is electrically connected to the elastic support assembly, and the other end of the conductive member is used to connect an external device.

Compared with the related art, in the sensor driving device of the present application, the driving coils are fixed to the sensor module. The driving coils include a plurality of groups, which are spaced apart from each other. Each group of driving coils includes two coils perpendicular to each other, and the driving directions of the two coils of each group are perpendicular to the optical axis toward the sensor module and perpendicular to the optical axis back away from the sensor module, respectively. An orthographic projection of one coil of each group of two coils toward the other coil is at least partially located within the other coil. The driving magnets include a plurality of groups, which are spaced apart from each other. Each group of driving magnets is spaced apart from each group of driving coils correspondingly; the plurality of groups of driving magnets interact with the plurality of groups of driving coils to drive the sensor module to move in a direction perpendicular to the optical axis. The opposite-top design of the driving coils allows for greater rotational torque when the same BL conditions are met, and multiple groups of driving coils can be utilized in series to obtain greater rotational thrust through an amplifier design.

### BRIEF DESCRIPTION OF THE DRAWINGS

In order to more clearly illustrate the technical solutions in the embodiments of the present application, the accompanying drawings to be used in the description of the embodiments will be briefly introduced below. Obviously, the accompanying drawings in the following description are only some of the embodiments of the present application, and for the people of ordinary skill in the field, other accompanying drawings can be obtained based on these drawings without creative labor.

FIG. 1 shows a three-dimensional structural schematic diagram of a sensor driving device of the present application.

FIG. 2 shows a schematic diagram of an overall exploded structure of the sensor driving device of the present application.

FIG. 3 is a schematic diagram showing a driving force direction of the driving coil of the present application.

FIG. 4 shows a sectional diagram along a line A-A in FIG. 1.

100, sensor driving device; 1, housing; 11, bottom cover; 12, top cover; 121, top cover body; 122, support portion; 123, second fixing portion; 124, third fixing portion; 13, through-hole; 2, elastic support assembly; 21, elastic arm; 22, mounting portion; 23, connecting portion; 24, movable portion; 25, first fixing portion; 3, conductive member; 4, sensor module; 5, driving coil; 51, first group of driving coils; 52, second group of driving coils; 53, third group of driving coils; 54, fourth group of driving coils; 6, driving magnet; 61, first driving magnet; 62, second driving magnet; 63, third driving magnet; 64, fourth driving magnet; 7, first anti-collision block; 8, second anti-collision block; 9, first damping member; and 10, second damping member.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by the person of ordinary skill in the field without making creative labor are within the scope of protection of the present application.

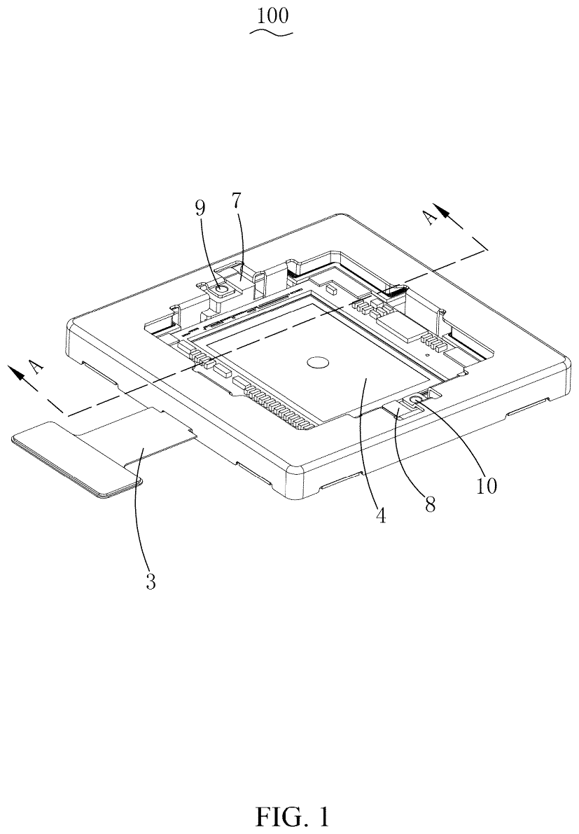

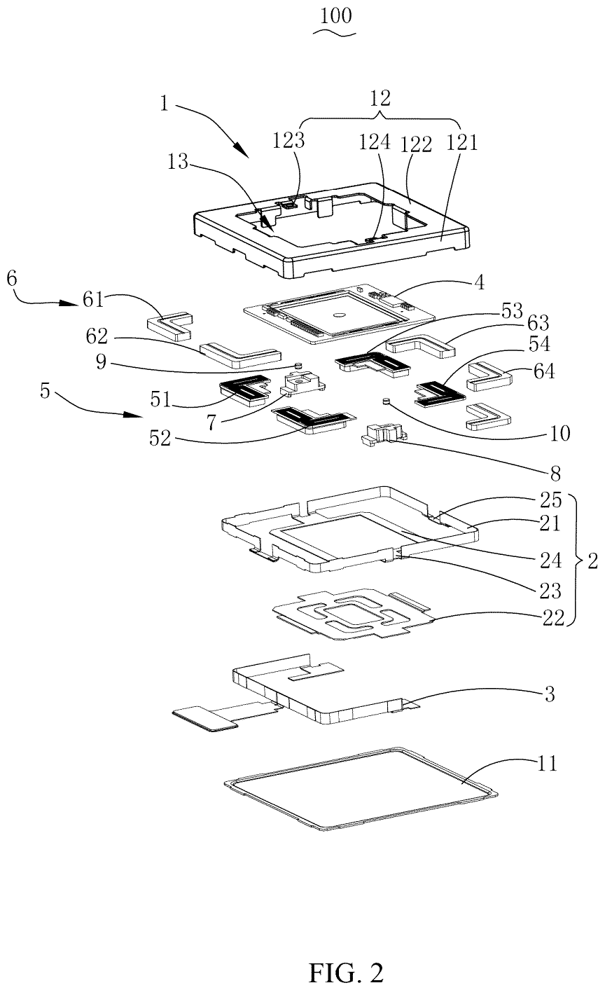

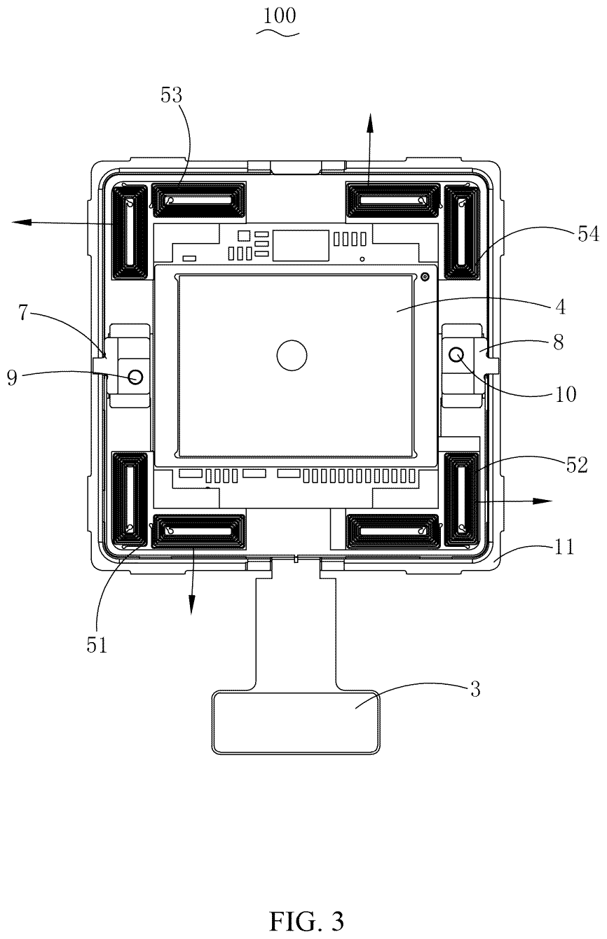

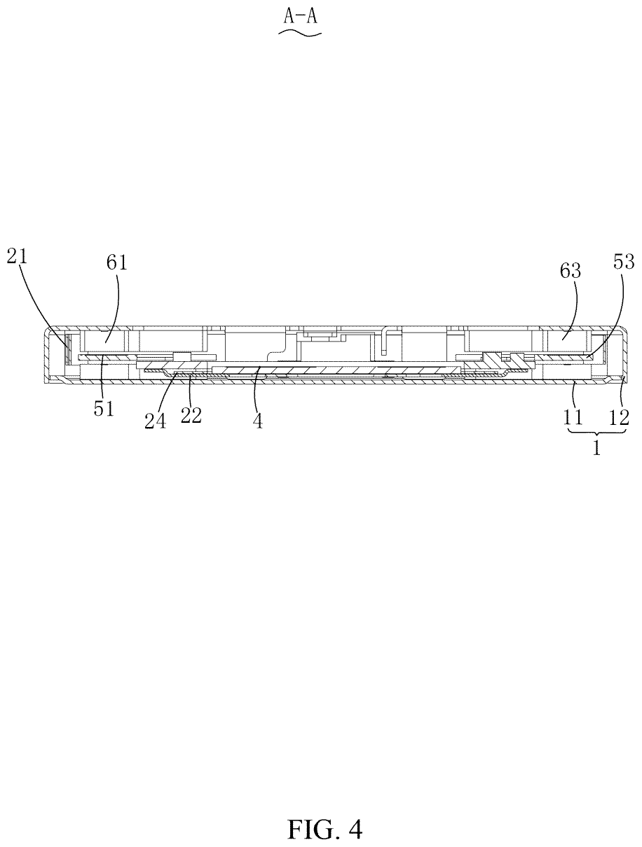

As shown in FIGS. 1-4, provided is a sensor driving device 100, including a housing 1, an elastic support assembly 2, a sensor module 4, driving coils 5, and driving magnets 6.

The housing 1 is provided with an accommodating space and a through-hole 13 connecting the accommodating space to the outside world. The through-hole 13 facilitates corresponding installation of the sensor module 4.

The sensor module 4 is accommodated in the accommodating space and is directly opposite the through-hole 13.

The elastic support assembly 2 is fixed to an inner side of the housing 1 and suspends the sensor module 4 in the accommodating space. The sensor module 4 is elastically fixed by means of the elastic support assembly 2 and the anti-shaking of the sensor module 4 is realized by means of the driving of the driving coils 5 and the driving magnets 6.

The driving coils 5 are fixed to the sensor module 4, and the driving magnets 6 are fixed to the housing 1 and spaced opposite the driving coils 5. The driving coils 5 interact with the driving magnets 6 and drive the elastic support assembly 2 in a direction perpendicular to the optical axis of the sensor module 4 to drive the sensor module 4 in synchronization.

In this embodiment, the driving coils 5 include a plurality of groups, which are spaced apart from each other. Each group of the driving coils 5 includes two coils perpendicular to each other, and the two coils of each group are driven in a direction perpendicular to the optical axis towards the sensor module 4 and perpendicular to the optical axis back away from the sensor module 4, respectively. An orthographic projection of one coil of each group toward the other coil is at least partially located within the other coil.

The driving magnets 6 include a plurality of groups, which are spaced apart from each other. Each group of the driving magnets 6 is spaced apart from each group of the driving coils 5 correspondingly. The plurality of group of the driving magnets 6 interact with the plurality of groups of the driving coils 5 to drive the sensor module 4 to move in a direction perpendicular to the optical axis. In this way, the opposite-top design of the driving coils 5 allows for greater rotational torque when the same BL conditions are met, and multiple groups of driving coils 5 can be utilized in series to obtain greater rotational thrust through an amplifier design.

In this embodiment, the orthographic projection of one coil of each group toward the other coil is located flush with the other coil.

In this embodiment, the elastic support assembly 2 is a rectangular structure and the driving coils 5 are located at four corner positions of the rectangular structure, facilitating a greater rotational torque to be obtained from the opposite top design of the drive coils 5 while satisfying the same BL conditions.

In this embodiment, the plurality of the driving coils 5 includes a first group of driving coils 51, a second group of driving coils 52, a third group of driving coils 53 and a fourth group of driving coils 54 respectively fixed to a peripheral side of the sensor module 4. The first group of driving coils 51 and the second group of driving coils 52 are spaced side by side and located on one side of the sensor module 4, and the third group of driving coils 53 and the fourth group of driving coils 54 are spaced side by side and located on the other side of the sensor module 4. The first group of driving coils 51 and the fourth group of driving coils 54 are provided diagonally to each other.

The driving magnets 6 include a first driving magnet 61, a second driving magnet 62, a third driving magnet 63, and a fourth driving magnet 64 respectively fixed to the housing 1. The first driving magnet 61, the second driving magnet 62, the third driving magnet 63, and the fourth driving magnet 64 are spaced apart from each other and located at the peripheral side of the sensor module 4. The first driving magnet 61, the second driving magnet 62, the third driving magnet 63, and the fourth driving magnet 64 interact with the first group of driving coils 51, the second group of driving coils 52, the third group of driving coils 53 and the fourth group of driving coils 54, respectively, and drive the sensor module 4 to move. The opposite-top design of the driving coils 5 allows for greater rotational torque when the same BL conditions are met, and four groups of driving coils 5 can be utilized in series to obtain greater rotational thrust through an amplifier design.

In this embodiment, one coil of the first group of driving coils 51 and one coil of the second group of driving coils 52 are parallel to each other and driven in the same direction, and the other coil of the first group of driving coils 51 and the other coil of the second group of driving coils 52 are flush with each other and driven in the opposite direction.

One coil of the first group of driving coils 51 and one coil of the third group of driving coils 53 are flush with each other and driven in the opposite direction, and the other coil of the first group of driving coils 51 and the other coil of the third group of driving coils 53 are parallel to each other and driven in the same direction.

One coil of the first group of driving coils 51 and one coil of the fourth group of driving coils 54 are parallel to each other and driven in opposite directions, and the other coil of the first group of driving coils 51 and the other coil of the fourth group of driving coils 54 are parallel to each other and driven in opposite directions.

In this embodiment, the elastic support assembly 2 includes an elastic arm 21 provided in the housing, two connecting portions 23 respectively extending from opposite sides of the elastic arm 21 toward an inner side of the elastic arm 21, a movable portion 24 fixed between the two connecting portions 23, a first fixing portion 25 formed by recessing the other opposite sides of the elastic arm 21, and a mounting portion 22 fixed to a side of the movable portion 24 away from the sensor module 4. The first fixing portion 25 is fixed to the housing.

In this embodiment, the sensor driving device 100 further includes a first anti-collision block 7 and a second anti-collision block 8. The first anti-collision block 7 and the second anti-collision block 8 are spaced apart on opposite sides of the sensor module 4. The first anti-collision block 7 and the second anti-collision block 8 are provided on the two connecting portions 23, respectively. A side of the first anti-collision block 7 away from the elastic arm 21 and a side of the second anti-collision block 8 away from the elastic arm 21 are abutted against the movable portion 24. The first anti-collision block 7 and the second anti-collision block 8 are configured to limit the rotational position of the sensor module 4, preventing the sensor module 4 from rotating too much, and providing a high degree of safety.

In this embodiment, the sensor driving device 100 further includes a first damping member 9, and a second damping member 10. Opposite ends of the first damping member 9 are fixed to the housing 1 and the first anti-collision block 7, respectively, and opposite ends of the second damping member 10 are fixed to the housing 1 and the second anti-collision block 8, respectively, thereby improving the anti-collision effect of the anti-collision block.

In this embodiment, the housing 1 includes a bottom cover 11 and a top cover 12 fixed to the bottom cover 11 and enclosing the accommodating space together with the bottom cover 11, and the elastic support assembly 2 is fixed to a side of the bottom cover 11 close to the top cover 12. The through-hole 13 is formed in the upper cover 12.

The first driving magnet 61, the second driving magnet 62, the third driving magnet 63, and the fourth driving magnet 64 are each provided with two magnets. The two magnets are fixed to the bottom cover 11 and the top cover 12, respectively. The two magnets are spaced apart on two sides of the first group of driving coils 51, the second group of driving coils 52, the third group of driving coils 53, and the fourth group of driving coils 54.

In this embodiment, the top cover 12 includes a top cover body 121 fixed to the bottom cover 11 and in a rectangular shape, a support portion 122 formed by an end of the top cover body 121 away from the bottom cover 11 extending along one side of the sensor module 4, and a second fixing portion 123 and a third fixing portion 124 formed by a side of the support portion 122 close to the bottom cover 11 bending and extending oppositely. The through-hole 13 is formed in the support portion 122, and the first damping member 9 and the second damping member 10 are provided on a side of the second fixing portion 123 close to the bottom cover 11 and a side of the third fixing portion 124 close to the bottom cover 11, respectively.

In this embodiment, the sensor driving device 100 further includes a first screw 9 and a second screw 10, the first damper 7 being fixedly connected to the second fixing portion 123 by the first screw 9, and the second damper 8 is fixedly connected to the third fixing portion 124 by the second screw 10. The screw fixation is effective and at the same time easy to assemble.

In this embodiment, the sensor driving device 100 further includes a conductive member 3. One end of the conductive member 3 is electrically connected to the elastic support assembly 2, and the other end of the conductive member 3 is used to connect an external device.

Compared to the related art, in the sensor driving device of the present application, the driving coils are fixed to the sensor module. The driving coils include a plurality of groups, which are spaced apart from each other. Each group of driving coils includes two coils perpendicular to each other, and the driving directions of the two coils of each group are perpendicular to the optical axis toward the sensor module and perpendicular to the optical axis back away from the sensor module, respectively. An orthographic projection of one coil of each group of two coils toward the other coil is at least partially located within the other coil. The driving magnets include a plurality of groups, which are spaced apart from each other. Each group of driving magnets is spaced apart from each group of driving coils correspondingly; the plurality of groups of driving magnets interact with the plurality of groups of driving coils to drive the sensor module to move in a direction perpendicular to the optical axis. The opposite-top design of the driving coils allows for greater rotational torque when the same BL conditions are met, and multiple groups of driving coils can be utilized in series to obtain greater rotational thrust through an amplifier design.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A sensor driving device comprising:
a housing provided with an accommodating space and a through-hole connecting the accommodating space to the outside world;
a sensor module accommodated within the accommodating space and directly opposite the through-hole;
an elastic support assembly fixed to an inner side of the housing and suspending the sensor module within the accommodating space;
driving coils fixed to the sensor module; and
driving magnets fixed to the housing and spaced opposite the driving coil; wherein the driving coils interact with the driving magnets and drive the elastic support assembly to move in a direction perpendicular to an optical axis of the sensor module, to drive the sensor module in synchronous movement;
wherein the driving coils comprise a plurality of groups, which are spaced apart from each other; each group of the driving coils comprises two coils perpendicular to each other, driving directions of the two coils of each group are perpendicular to the optical axis toward the sensor module and perpendicular to the optical axis back away from the sensor module, respectively; and an orthographic projection of one coil of each group toward the other coil is at least partially located within the other coil;
the driving magnets comprise a plurality of groups, which are spaced apart from each other; each group of the driving magnets is spaced apart from each group of the driving coils correspondingly, and the plurality of groups of the driving magnets interact with the plurality of groups of the driving coils to drive the sensor module to move in a direction perpendicular to the optical axis.

2. The sensor driving device of claim 1, wherein the orthographic projection of one coil of each group toward the other coil is located flush with the other coil.

3. The sensor driving device of claim 1, wherein the plurality of groups of the driving coils comprise a first group of driving coils, a second group of driving coils, a third group of driving coils, and a fourth group of driving coils respectively fixed to a peripheral side of the sensor module; wherein the first group of driving coils and the second group of driving coils are spaced side by side and located on one side of the sensor module, the third group of driving coils and the fourth group of driving coils are spaced side by side and located on the other side of the sensor module; and the first group of driving coils and the fourth group of driving coils are provided diagonally;
the driving magnets comprise a first driving magnet, a second driving magnet, a third driving magnet, and a fourth driving magnet respectively fixed to the housing; wherein the first driving magnet, the second driving magnet, the third driving magnet, and the fourth driving magnet are spaced apart from each other and located at the peripheral side of the sensor module; the first driving magnet, the second driving magnet, the third driving magnet, and the fourth driving magnet interact with the first group of driving coils, the second group of driving coils, the third group of driving coils, and the fourth group of driving coils, respectively, and drive the sensor module to move.

4. The sensor driving device of claim 3, wherein one coil of the first group of driving coils and one coil of the second group of driving coils are parallel to each other and driven in the same direction, and the other coil of the first group of driving coils and the other coil of the second group of driving coils are flush with each other and driven in the opposite direction;
one coil of the first group of driving coils and one coil of the third group of driving coils are flush with each other and driven in the opposite direction, and the other coil of the first group of driving coils and the other coil of the third group of driving coils are parallel to each other and driven in the same direction;
one coil of the first group of driving coils and one coil of the fourth group of driving coils are parallel to each other and driven in the opposite direction, and the other coil of the first group of driving coils and the other coil of the fourth group of driving coils are parallel to each other and driven in the opposite direction.

5. The sensor driving device of claim 3, wherein the elastic support assembly comprises an elastic arm provided in the housing, two connecting portions respectively extending from opposite sides of the elastic arm toward an inner side of the elastic arm, a movable portion fixed between the two connecting portions, a first fixing portion formed by recessing the other opposite sides of the elastic arm, and a mounting portion fixed to a side of the movable portion away from the sensor module; the sensor module is fixed to the mounting portion and the first fixing portion is fixed to the housing.

6. The sensor driving device of claim 5, further comprising a first anti-collision block and a second anti-collision block, wherein the first anti-collision block and the second anti-collision block are provided on the two connecting portions, respectively; and a side of the first anti-collision block away from the elastic arm and a side of the second anti-collision block away from the elastic arm are abutted against the movable portion.

7. The sensor driving device of claim 6, further comprising a first damping member and a second damping member, wherein opposite ends of the first damping member are fixed to the housing and the first anti-collision block, respectively; and opposite ends of the second damping member are fixed to the housing and the second anti-collision block, respectively.

8. The sensor driving device of claim 7, wherein the housing comprises a bottom cover and an upper cover fixed to the bottom cover and enclosing the accommodating space together with the upper cover; the elastic support assembly is fixed to a side of the bottom cover close to the upper cover;
the first driving magnet, the second driving magnet, the third driving magnet, and the fourth driving magnet are each provided with two magnets; the two magnets are fixed to the bottom cover and the top cover, respectively; and the two magnets are spaced apart on two sides of the first group of driving coils, the second group of driving coils, the third group of driving coils, and the fourth group of driving coils.

9. The sensor driving device of claim 8, wherein the top cover comprises a top cover body fixed to the bottom cover and in a rectangular shape, a support portion formed by an end of the top cover body away from the bottom cover extending along one side of the sensor module, and a second fixing portion and a third fixing portion formed by a side of the support portion close to the bottom cover bending and extending oppositely; the through-hole is formed in the support portion, and the first damping member and the second damping member are provided on a side of the second fixing portion close to the bottom cover and a side of the third fixing portion close to the bottom cover, respectively.

10. The sensor driving device of claim 1, further comprising a conductive member, wherein one end of the conductive member is electrically connected to the elastic support assembly, and the other end of the conductive member is used to connect an external device.
